(19) United States
(12) Patent Application Publication
(10) Pub. No.: US 2023/0076834 A1
(43) Pub. Date: Mar. 9, 2023

(54) COMPOSITIONS AND METHODS FOR ELECTRO-CHEMICAL CELL COMPONENT FABRICATION

(71) Applicant: Navitas Systems, LLC, Lisle, IL (US)

(72) Inventors: Binson Li, Ann Arbor, MI (US); Robert Sosik, Ann Arbor, MI (US); Michael Wixom, Ann Arbor, MI (US)

(21) Appl. No.: 17/905,374

(22) PCT Filed: Mar. 1, 2021
(86) PCT No.: PCT/US2021/020234

§ 371 Date: Aug. 31, 2022

Related U.S. Application Data
(60) Provisional application No. 62/984,144, filed on Mar. 2, 2020.

(51) Int. Cl. H01M 4/04; H01M 10/0525; H01M 4/62; C08J 5/18; C08K 3/04

(52) U.S. Cl. CPC H01M 4/0433; H01M 10/0525; H01M 4/62; C08J 5/18; C08K 3/04; H01M 2004/021

(57) ABSTRACT

Provided are methods of producing materials suitable for use as a component of an electrochemical cell such as electrode active layers or solid state electrolyte and/or separator materials. Processes include combining an active with a fibrillizable binder and intermixing in a screw fibrillator to produce a fibrillized material with greatly increased physical and optionally electrochemically characteristics relative to those materials produced by other processes such as simple slurry casting or intermixing in a jet mill.

### CROSS REFERENCE TO RELATED APPLICATIONS

This application depends from and claims priority to U.S. Provisional Application No: 62/984,144, filed Mar. 2, 2020, the entire contents of which are incorporated herein by reference.

### STATEMENT OF GOVERNMENT RIGHTS

This disclosure was created with Government support under Contract No. DE-EE0008231 awarded by the U.S. Department of Energy. The Government has certain rights in this invention.

### FIELD

The disclosure relates to batteries and methods for forming electrodes, solid-state electrolyte (SSE), electrode/SSE composite or electrode/SSE multilayer membranes with excellent mechanical and electrochemical properties. More specifically, the disclosure relates to methods for forming materials suitable for use in batteries or ultracapacitors.

### BACKGROUND

Typical electrode manufacturing techniques for use in an electrochemical cell include the formation of an active electrode material that is then coated or extruded onto a conductive substrate. The active electrode material is mixed with a binder that serves to associate the electrochemically active materials. These binders are commonly polymers or resins. To assist in formation of a proper binder, formulations use additives such as solvents, plasticizers, or liquids to dissolve the binder material to form a wet slurry that can effectively be coated onto a conductive substrate.

In a conventional battery, the polymer binder is dissolved or suspended in the solvent and coats the surrounding active particles. When solvent is removed the polymers become sticky and provide the adhesion to a substrate or cohesion between particles. During this process, the solvent remains intermixed with the binder and electrochemically active material as a wet slurry. Following association with the conductive substrate, the wet slurry is then dried to remove the solvent as the continued presence of such additives is commonly detrimental to cell performance. Unfortunately, the drying process must be carefully controlled to attain desired mechanical and electrochemical properties. This limits electrode fabrication throughput and required drying ovens with high capital and operating expense.

Dry and low-solvent binder formulations have been attempted to reduce or eliminate the drying step by using high shear mixing to fibrillate the binder. The fibrillated binder creates a web-like structure that holds the materials together. Fibrillization is often promoted through the use of fibrillation promotors. Activated carbon (AC) is an effective fibrillation promotor used to promote binder fibrillization. Activated carbon is derived from pyrolyzing and “activating” a highly cross-linked cellulosic polymer precursor. The cross-linking provides a high degree of mechanical strength, which is desired during high shear mixing. The active carbon particle mechanical properties are more isotropic than many graphitic carbon materials. Activation also results in a high degree of nanoporosity and the creation of hydrophilic surface functional groups, which tightly bond water. For commercial applications, AC powders are typically milled to tens of micrometers (μm) particle dimensions prior to activation.

The dry process of battery cathodes typically involves the use of a milling operation such as a jet mill, ball mill or knife mill. The purpose of these mills is to fibrillate and disperse the binder throughout the dry electrode active materials. Unfortunately, these processes are limited to pilot scale demonstrations, used for cathode materials only due to limited types of suitably fibrillizable binder materials, and at active material fractions that trail state of the art commercial electrodes. In these dry processes the amount of binder necessary to yield robust electrode film structure is typically greater than that in other methods, resulting in lower electrode conductivity. Also, the typically used dry processes result in an incomplete dispersion of the fibrillated binder, and thus prevent dry process from being used in anodes, other cathode technologies and solid-state electrolyte materials.

As such, new materials and methods are needed to improve mechanical properties and processibility of materials used in batteries and/or ultracapacitors.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are film materials suitable for use in an electrochemical cell as an electrode active material or a solid state electrolyte or both as well as processes of forming such materials. The processes as provided herein result, in some aspects, in robust films with improved physical and/or electrochemical characteristics relative to cells produced using traditionally applied mixing produces such as a jet mill or blade blender and optionally require little (e.g. optionally less than 5 weight percent) binder amounts thereby increasing active material loading relative to prior systems.

Processes as provided herein include combining an electrochemically active material or a solid-state electrolyte material with a fibrillizable binder to form a precursor material; and

intermixing said precursor material in a screw fibrillator to form a fibrillized material. The processes may be used in dry process applications such as where the precursor materials include less than 30 wt % liquid. A binder may be present at significantly low levels, yet result in a robust film. Binder levels in the processes and materials as produced herein are optionally at 5 weight percent or less. Active material fractions in the resulting materials are optionally at or in excess of 50 mol %, optionally at or in excess of 95 mol %.

Also provided are cells, optionally solid state cells or batteries that include an electrode or electrolyte produced using the processes as provided herein.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 illustrates a generalized schematic of production of a film for use in an electrode according to some aspects as provided herein;

FIG. 2 illustrates a flow charge of a process of forming a fibrillized product according to some aspects as provided herein;

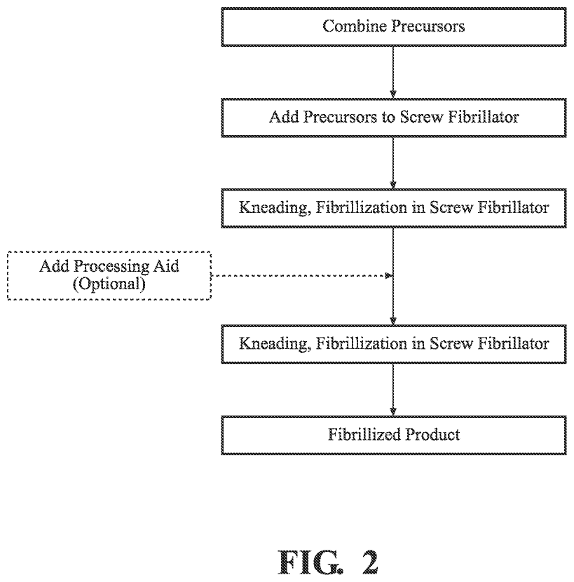

FIG. 3 is a schematic of exemplary screw elements in a twin-screw fibrillator as used in some aspects as provided herein;

FIG. 4 illustrates SEM images and EDS mapping of electrode materials made according to aspects as provided herein (b and d, respectively) and a comparator material made using a jet mill (a and c, respectively);

FIG. 5 illustrates thorough plane resistance of single or double sided anodes made with anode films produced according to some aspects as provided herein or by traditional slurry cast processes illustrating much lower resistivity of the electrode films produced as provided herein; and

FIG. 6 illustrates electrochemical characterization of graphite anodes formed using a screw fibrillator as provided herein (squares) relative to cells including compositionally identical anodes but formed using simple blender processes demonstrating electrochemical superiority of cells with a component produced as provided herein.

### DETAILED DESCRIPTION

This disclosure provides methods that improve the fibrillation of binder materials making low solvent processes suitable for more material types and/or allows the use of less binder and/or processing additives during manufacture of electrodes, solid-state electrolytes, electrode/SSE composites or electrode/SSE multilayer membranes with excellent mechanical properties. As such, electrochemical cells or portions thereof can be produced using the processes as provided herein that increase the electrochemically active material fraction in the resulting systems relative to other methods. The processes as provided herein employ a screw fibrillator in the blending processes for the production of electrodes, solid-state electrolyte or composite and multilayer films where the processes are capable of reducing greater than 60% of electrode manufacturing costs compared to current state of the art commercial slurry case electrode processes.

It was found that by blending electrode materials in a screw fibrillator, materials produced using a low solvent (<10 wt %) process show significant structural, physical, cycle life and/or specific capacity improvements over prior low solvent process electrode manufacturing. As such, the processes provided herein are able to not only eliminate all or substantially all of the solvent(s) or additive(s) used in prior slurry cast electrode processes, but also extend prior low solvent electrode processing to be useful for multiple electrode and solid-state electrolyte types and materials.

The processes as provided herein are able to address the common shortfalls of slurry cast electrodes since little to no solvent drying is required following electrode formation, reducing capital costs, processing time, and energy costs, while at the same time improving industrial hygiene. These processes also allow for the formation of relatively thicker electrodes for a higher cell-level specific energy, which are not achievable in regular slurry cast electrodes or require extra treatments and increased costs.

Further, the processes as provided herein address issues with prior use of fibrillizable binder materials such as polytetrafluoroethylene (PTFE) and the use of jet mill processing systems. PTFE, for example, is not electrochemically stable at the anode, resulting in loss of capacity and mechanical strength and effectively preventing its application in anode formation by jet mill processes. Moreover, the jet mill blending cannot effectively fibrillate PTFE binder when present at low levels and requires high content of binder for mechanical quality, which decreases the electrode energy density and ionic conductivity. The currently provided screw fibrillator processes are highly effective at binder fibrillization, enabling reduction/minimization of the binder amount and reduce/eliminate the need for fibrillization promoters or processing steps that add cost and detract from performance by limiting active material content in current dry process electrodes.

As used herein, a “screw fibrillator” is defined as any device capable of providing suitable shear force and compressive forces to promote fibril formation from one or more of the components subjected to the processes of the screw fibrillator. Illustrative examples of screw fibrillators include, but are not limited to twin-screw extruders (TSE), single screw extruders, kneaders, grinding mills, or push-pull milling operations. Optionally, a screw fibrillator is limited to a fibrillator that employs one or more screws (e.g. TSE, single screw extruder) or a push-pull mill. A screw fibrillator optionally excludes a jet mill or blade blender.

As used herein, an “electrochemical cell” is defined as a device that is capable of storing energy. Illustratively, an electrochemical cell may store energy electrochemically or electrostatically. An electrochemical cell includes a cell as understood to be used in a battery or an ultracapacitor.

As used herein, “absorbing” can mean: intercalation or insertion or conversion alloying reactions of lithium with the active materials.

As used herein, “desorbing” can mean: de-intercalation or de-insertion or conversion de-alloying reactions of lithium with the active materials.

As used herein, in the context of the Li-ion cell, “cathode” means positive electrode and “anode” means the negative electrode.

As used herein an “active material” is a material that participates in electrochemical charge/discharge reaction of an electrochemical cell such as by absorbing or desorbing lithium.

As used herein, “fibrillize” can mean processing into the formation of fibrils.

As used herein, “intermixing” can mean forming a mixture by mixing a mass of ingredients. Intermixing can mean high-shear mixing to effect fibrillization.

As used herein, “mechanical strength” can mean the ability of a material to withstand an applied load without failure or deformation.

As used herein, “surface roughness” can mean the roughness or a surface texture defined by deviations in the normal vector of a real surface from its ideal form. Surface roughness may include complex shapes made of a series of peaks and troughs/pores of varying heights, depths, and spacing.

Provided are processes that capitalize on blending electrochemically active materials with a fibrillatable binder material using a screw fibrillator in a dry process manufacturing method. It was unexpectedly found that the processes as provided herein improved the processing characteristics and electrochemical and mechanical properties of resulting electrodes and allowed for the use of lower solvent, binder, and/or additive amounts to thereby increase the active fraction of active materials. While this disclosure describes the use of a TSE, this is an example only. In some aspects, other processing methods may be substituted or added to the TSE screw extruder such as single screw extruders, kneaders, grinding mills, or push-pull milling operations. Optionally, a process as provided herein cannot substitute a TSE for another milling process due to superior results using the TSE method. Optionally, processes as provided herein exclude processing in a jet mill.

The electrode precursor materials (e.g. electrochemically active material, binder, fibrillization promoter, or combination thereof) optionally contain no more water or other liquid solvent than the ambient atmosphere, optionally less than 1 weight percent (wt %) of any liquid including for example solvents (e.g. NMP, etc), water, ethanol, or the like. In some aspects, a small amount of solvent as is typically used in slurry cast electrodes, or other processing aids such as polyvinyl alcohol or isopropyl alcohol (IPA), may be included in the system at less than 40 weight percent, optionally less than 20 weight percent, optionally less than 10 weight percent, to reduce the extruding resistance, but most of it will evaporate during extrusion due to low boiling point and requires no further drying. Complete dry processes are also envisioned in which no liquid is added to the processing steps, or is otherwise present during the processing steps within the screw fibrillator.

As such, a process as provided herein includes combining one or more electrochemically active materials or solid-state electrolyte materials with one or more fibrillizable binders to form a precursor material. One or more optional processing aids or other additives that are compatible with the other materials and the resulting use (e.g. cathode, anode, solid-state electrolyte film, ultracapacitor electrode, etc.) may also be included in the precursor material. The combined materials (or combined within the screw fibrillator) are processed through a screw fibrillator optionally using an inert processing atmosphere and/or vacuum conditions.

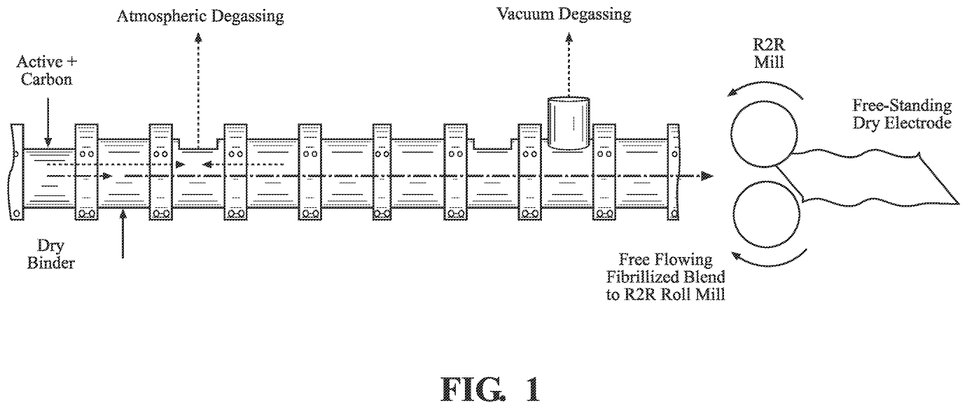

In FIG. 1, an exemplary screw fibrillator is illustrated in the form of a twin-screw extruder that may be used to increase throughput and degree of PTFE binder fibrillization versus a jet mill. A screw fibrillator provides superior control over a range of viscosity and shear energy and can be performed under inert or vacuum conditions and at temperatures up to >300° C., with temperature optionally varying by zone. Within the screw fibrillator, the active material, fibrillizable binder, and optional fibrillization promoter (illustrated as activated carbon in FIG. 1 as an example only) may be degassed by flowing an inert atmosphere over the materials.

Also as noted in FIG. 1, one or more processing aids, such as a lubricant or other, may also be introduced into the screw fibrillator during the fibrillization process. A processing aid may be a sacrificial processing aid meaning that the lubricant is eventually removed from the system such as by volatization, evaporation, washing, etc, optionally during the fibrillization process within the screw fibrillator. One illustrative example of a sacrificial processing aid is isopropyl alcohol (IPA).

Alternatively or in addition, the processing aid may be cofunctional meaning that the processing aid functions in conjunction with the one or more other components of the system to support or further improve properties of the resulting material subjected to screw fibrillator. Illustrative, non-limiting examples of a cofunctional processing aid include, but are not limited to lower MW or lower melting point polyolefins that melt or flow in the TSE and/or oligomers that may be later are cross-linked, optionally that liquefy under the conditions of the screw fibrillator, but may solidify in the final material. Additional examples of cofunctional processing aids include alkyl carbonates or other elyte components.

A processing aid may be a solid or a liquid. Optionally, a solid processing aid (e.g. copolymer) may be solid at room temperature but will be a liquid at the temperature of the fibrillization process within the screw fibrillator. The screw fibrillator process may further or in substitution include degassing under vacuum. The resulting fibrillized material may then be used for subsequent processing.

The use of a screw fibrillator to blend the powders and fibrillate the binder in the precursor material allows for the use of binder materials that were previously not successful for anode production by prior processes. As such, the processes as provided herein allow for the use of binders such as, illustratively, polytetrafluoroethylene (PTFE) or polyvinylidene fluoride (PVDF), as examples, powders that may be blended into active materials and fibrillated under the mixing as occurs in the screw fibrillator.

One advantage of the provided processes is the ability to increase the fraction of active material or solid-state electrolyte material and maintain or improve physical or electrochemical characteristics of the resulting films. For example, an active material or solid-state electrolyte material fraction in a film produced by the present process optionally exceeds 50 mol %. Optionally, the active material or solid-state electrolyte material fraction in a film produced by the present process optionally exceeds 60 mol %, optionally 70 mol %, optionally 80 mol %, optionally 90 mol %, optionally 95 mol %, optionally 97 mol %, optionally 98 mol %, optionally 99 mol %.

In addition, the processes as provided herein can be employed in dry processing of materials suitable for use as an active in an electrode or as a solid-state electrolyte material. The ability of the processes to create fibril formation to improve binder function not only allows the inclusion to lower amounts of such binder, if desired, but also allows for processing with little to no liquid. Traditional electrode formation processes include a solvent with the active material that when combined with a binder forms a slurry. Subsequent processing removes the solvent to leave the final electrode active material. The provided processes herein, however, do not require the use of a solvent for electrode formation. As such, the amount of liquid or solvent in the precursor material, the fibrillized material, or both, is optionally at or less than 30 wt %, optionally at or less than 25 wt %, 20 wt %, 15 wt %, 10 wt %, 5 wt %, 4 wt %, 3 wt %, 2 wt % or 1 wt %, or less.

As such, the processes as provided herein optionally intermix the electrochemically active material or a solid-state electrolyte material with the fibrillizable binder by traditional, low shear techniques. Such low shear techniques are illustratively those that do not lead to fibrillization of a fibrillizable binder therein. Simple intermixing is optionally a method by which the electrochemically active material or a solid-state electrolyte material is combined with the fibrillizable binder. Optionally, the precursor materials may be combined by stirring, agitating, shaking, low speed blending, low shear milling, or other low shear method.

The step of combining the electrochemically active material or a solid-state electrolyte material with the fibrillizable binder is optionally performed at an elevated temperature. An elevated temperature is any temperature that is equal to or greater than 15° C. but less than a calcination temperature of the materials being intermixed. Optionally, a temperature is at or in excess of 25° C., optionally 30° C. Optionally, a step of intermixing and/or a step of subjecting the precursor materials to the screw fibrillator is at a temperature at which one or more liquids will become volatile and be removed by vaporization, and/or at a temperature in which one or more of the components in the precursor material becomes liquid to thereby increase lubricity of the precursor material during as it passes through the screw fibrillator.

Among the advantages of the processes as provided herein, the use of PTFE as a fibrillizable binder is not absolutely required. Due to the ability of the processes to improve fibrillization of the binder material, other binders may substitute for or be added to PTFE binder. This for the first time extends the use of dry electrode processing to anodes that include electrochemically active materials that are adverse to the use of PTFE binders. As such, a fibrillizable binder as used in the processes as provided herein optionally includes or excludes a fibrillizable fluoropolymer, optionally polytetrafluoroethylene (PTFE). Illustrative examples of fibrillizable binders include ultra-high molecular weight polypropylene, polyethylene, co-polymers, polymer blends and the like. Optionally, a binder material is optionally a combination of any of two or more of the foregoing. A fibrillizable binder is optionally PTFE or a copolymer of PTFE and another polymer(s). Binders such as PTFE or polyvinylidiene fluoride (PVDF) powders may be blended into active materials and fibrillated under high-shear.

For anode active materials, a binder is optionally a copolymer of PVDF with one or more other copolymers. Optionally, a binder for anode active materials is a copolymer of PVDF and PTFE. Optionally, a binder for an anode active material is a copolymer of PVDF with one or more of PTFE, polypropylene, or polyethylene.

Optionally, the binder in unfibrillated form has a molecular weight of about 1×10⁶ g/mol to about 10×10⁶ g/mol. Optionally, the molecular weight of unfibrillated binder may range from about 2×10⁶ g/mol to about 6×10⁶ g/mol, optionally about 5×10⁶ g/mol.

A significant advantage of the processes as provided herein is that the amount of binder required to form a robust electrode and/or electrolyte film is lower than is required by prior low solvent process or slurry casting processes. Optionally, the amount of binder required in the system is less than 5 weight percent (wt %) relative to all materials mixed in the screw fibrillator combined. Optionally, the binder is present at 4.5 wt % or less, optionally 4 wt % or less, optionally 3.5 wt % or less, optionally 3 wt % or less, optionally 2.5 wt % or less, optionally 2 wt % or less.

A robust film for use as a portion of an electrode or as a solid state electrolyte is characterized by suitable mechanical properties that allow the materials to be used in many different cell types and/or resist mechanical abuse relative to other such materials. A robust film optionally has a Young's modulus at or in excess of 100 N/mm², optionally at or in excess of 120 N/mm². In some aspects, a robust film has a Young's modulus at or in excess of 125 N/mm², optionally 130 N/mm², optionally 140 N/mm², optionally 150 N/mm², optionally 160 N/mm², optionally 170 N/mm², optionally 180 N/mm², optionally 185 N/mm², optionally 190 N/mm².

A robust film optionally has a tensile strength at or in excess of greater than 0.6 N/mm², optionally at or in excess of 0.65 N/mm². In some aspects, a robust film has a tensile strength at or in excess of 0.7 N/mm², optionally 0.75 N/mm², optionally 0.8 N/mm², optionally 0.85 N/mm², optionally 0.9 N/mm².

Values of a robust film Young's modulus and tensile strength are optionally using a 60 mm long sample with a width of 20 mm with a thickness of 65 μm.

In some aspects, a process includes combining an electrochemically active material with PTFE as a fibrillizable binder, optionally wherein the PTFE is present at 4.5 wt % or less, optionally 4 wt % or less, optionally 3.5 wt % or less, optionally 3 wt % or less, optionally 2.5 wt % or less, optionally 2 wt % or less. Optionally, the process uses a screw fibrillator that is a twin screw extruder.

In some aspects, a process includes combining an electrochemically active material with a fibrillizable binder that is not PTFE alone, optionally wherein the fibrillizable binder is a copolymer of PVDF and PTFE, copolymer of PVDF with other one or more of ultra-high molecular weight polypropylene, polyethylene, other co-polymers, polymer blends and the like, wherein the fibrillizable binder is present at 4.5 wt % or less, optionally 4 wt % or less, optionally 3.5 wt % or less, optionally 3 wt % or less, optionally 2.5 wt % or less, optionally 2 wt % or less. Optionally, the process uses a screw fibrillator that is a twin screw extruder.

In the processes as provided herein, a fibrillization promoter may be included to promote binder fibrillization. Due to the unique use of a screw fibrillator, a fibrillization promoter is not required, but in some aspects may further promote fibril formation in the screw fibrillator. Optionally, a fibrillization promoter is activated carbon. Optionally, a fibrillization promoter is not activated carbon. A fibrillization promoter optionally has a surface roughness on a dimensional scale that is within 10% to 250% of that found in PTFE fibers. Such a surface is rough on a dimensional scale where roughness is defined as a plurality of hills and valleys on the surface of the fibrillization promoter. In some aspects of the disclosure, a surface roughness defines a porous surface structure, optionally a surface structure having high porosity. Illustrative examples of processing additives may be found in International Patent Application Publication No: WO 2017/197299.

In some aspects of the disclosure, the fibrillization promoter is capable of also improving electrolyte wetting or lithium ion transport, e.g. by maintaining porosity during calendering or enhancing the electrode affinity to the liquid electrolyte. For example, porosity of the fibrillization promoter decreases by less than half of the porosity before calendering. A fibrillization promoter may have a mechanical strength sufficient to survive high energy mixing typically used in the art to fibrillate a binder. As used herein, sufficient mechanical strength may be defined as the ability of the additive not to break apart during intermixing and produce fines. These rough and/or porous processing additives significantly improve overall processibility and mechanical strength when electrode materials are formed using a low or non-solvent process such as that described in U.S. Pat. No. 8,072,734.

Illustrative examples of a fibrillization promoter as used herein include activated carbon (AC) and a silica-templated high-porosity optionally graphitized carbon material with particle size distribution optionally peaking in about the 3 micrometer (μm) to about 5 micrometer (μm) range. A fibrillization promoter is optionally a graphitized particle, a pyrolized material, or any combination of activated carbon, silica-templated high-porosity particle, graphitized particle, or pyrolized material. In some aspects, the BET area of the fibrillization promoter is much less than conventional AC and the material is not activated and thus is less hydrophilic than AC. The graphitization process imparts mechanical strength comparable to the pyrolized highly-cross linked cellulosic precursor sources used to form AC. An illustrative example of a fibrillization promoter such as porous carbon is sold as POROCARB by Heraeus Quarzglas GmbH & Co. KG, Kleinostheim, Germany.

In some aspects of the disclosure, a fibrillization promoter is a hard carbon with mechanical properties similar to activated carbon with regard to properties such as particle strength, particle morphology, or surface roughness, which may contribute to the electrode processibility, but with lower porosity, lower surface area (e.g., as measured by gas adsorption), or less hydroscopic than activated carbon. An illustrative example of a hard carbon is sold as LBV-1 Hard Carbon from Sumitomo Bakelite Co., LTD. Such a material may be obtained from pyrolizing highly cross-linked cellulosic precursors. Whereas commercial ‘activated carbon’ materials are subjected to a pore-forming activation process prior to particle size reduction and classification, the desired exemplary processing additive may be formed by excluding the activation process. The exemplary processing additive optionally has a BET surface area <200 m²/g and preferably <20 m²/g, compared to areas >800 m²/g for commercial activated carbon. The fibrillization promoter optionally comprises a porous carbon additive sold as POROCARB. The processing addictive may be dispersed with the active electrode material by intermixing in a screw fibrillator as provided herein.

A fibrillization promoter is optionally present at a concentration relative to an overall precursor material. An overall weight percent concentration of fibrillization promoter is optionally from 2 percent to 10 percent, optionally from 2 percent to 6 percent, optionally from 4 percent to 8 percent, optionally at 5 percent by weight. In some aspects of the disclosure, the overall concentration of fibrillization promoter is optionally greater than or equal to 5 weight percent, optionally 5 weigh percent to 8 weight percent to greater, optionally when blended with an active material such as NMC, LMFP, LTO, or the like.

In some aspects, a process includes also combining one or more electrode additives that alter one or more physical or electrochemical characteristics of the resulting electrode. Illustratively, an electrode additive may be a conductive carbon. It is appreciated that activated carbon and conductive carbon are each conductive to relative degrees. Generally, for electrochemical purposes, however, activated carbon is not a conductive carbon as used herein. Conductive carbons are small (<1 μm) materials that disperse readily and/or may dry coat the electrode materials to provide electronic linkages through the electrode. (e.g., electron transport via percolation model). The dispersed conductive carbon network may be described in some cases as “chain of pearls.” In other cases, conductive carbons may be high aspect ratio fibers or platelets that can wrap powders and/or form a web type network. In some aspects, electrodes may use combinations of conductive carbons. On the other hand, activated carbon generally refers to very high surface area microporous materials. Conductive carbons may or may not be porous but in many cases are also high surface area but with more of the surface area due to exterior of small particles rather than internal pore volume as is the case for activated carbons. Commercial activated carbons are generally much larger particles than conductive carbons.

The processes as provided herein include the combination of one or more electrochemically active electrode or solid-state electrolyte materials with the binder and optional fibrillization promoter, electrode additive, solvent (if desired), etc. Electrochemically active materials optionally include or are lithiated or non-lithiated oxides of Nickel Manganese Cobalt (e.g. NMC622, NMC811, NMC532) (a.k.a. NCM or NMC), Lithium Manganese Spinel (LMO), Lithium Nickel Manganese Spinel (LNMO), Lithium Titanium Oxide (LTO), Lithium Nickel Cobalt Aluminum (NCA), Lithium Iron Phosphate (LFP), Iron Manganese Phosphate (LMFP), Lithium Cobalt Oxide (LCO), and graphite formulas, or combinations thereof. In particular examples, an electrochemically active material is one or more NCM materials, optionally at the exclusion of one or more other materials. Optionally, an electrochemically active material excludes a carbon material. Optionally, and electrochemically active material excludes activated carbon, carbon black, or both.

The active material optionally comprises 100% NMC, 80% NMC, 60% NMC, 50% NMC, 40% NMC, and 20% NMC. Optionally, the active material blended with the NMC is LMFP.

In some aspects, an active material is suitable for use in an anode of an electrochemical cell. Illustratively, such materials may include silicon, graphite, silicon carbon composites, or any combination thereof. Illustrative examples of a metal alloy for use as an active material include silicon alloys. A silicon alloy is optionally an alloy of silicon and Ge, Be, Ag, Al, Au, Cd, Ga, In, Sb, Sn, Zn, or combinations thereof. The ratio of the alloying metal(s) to silicon is optionally 5% to 2000% by weight, optionally 5% to 500% by weight, optionally 20% to 60% by weight, based on silicon.

In some aspects, an active material includes a lithium alloy. A lithium alloy optionally includes any metal or alloy that alloys with lithium, illustratively including Al, Si, Sn, Ag, Bi, Mg, Zn, In, Ge, Pb, Pd, Pt, Sb, Ti, tin alloys, and silicon alloys.

In some aspects, the electrochemically active material is replaced in whole or in part with a polymer or other solid electrolyte material so as to form a resulting solid state electrolyte (SSE) or combination SSE and electrode. The solid electrolyte material may include a polymer/ceramic composite solid electrolyte material based on a structurally modified lithium sulfide. A solid-state electrolyte may be formed of a polymer/ceramic composite solid electrolyte material. A solid-state electrolyte may be formed of an electrolyte material that is a dry material, a solid material, a ceramic material, or a glass-ceramic material. A solid-state electrolyte material may include one or more inorganic solid electrolyte materials (ISEs), solid polymer electrolyte materials (SPEs), or organic-inorganic hybrid composite electrolyte materials. Illustrative examples of solid-state electrolyte materials include, but are not limited to poly (ethylene oxide), polycarbonate, polysiloxane, succinonitrile, and organic-inorganic hybrid composites.

A solid-state electrolyte may include an organic-inorganic hybrid composites. Illustrative examples of an organic-inorganic hybrid composites optionally include lithium sulfide and/or a lithium phosphorus sulfide such as xLi₂S-yP₂S₅, or Li₃PS₄ (LPS; xLi₂S—yP₂S_{5,} where x=75 and y=25). In some aspects, a solid-state electrolyte may include a LiS—PS₅. Precursor materials are optionally lithium sulfide (Li₂S, 99.98%, Sigma-Aldrich) and phosphorus pentasulfide (P₂S₅, Sigma-Aldrich). Li₂S is optionally provided at 50 mol. % to 90 mol. %, or any value or range therebetween. Optionally, Li2S is provided at 60 mol. % to 80 mol. %, optionally 75 mol. %. P₂S₅ is optionally provided at 10 mol. % to 40 mol. %, or any value or range therebetween. P₂S₅ is optionally present at 20 mol. % to 30 mol. %, optionally 25 mol. %.

After fibrillization in the screw fibrillator, the fibrillized material(s) can be compressed into a free-standing, laminated or multilayer film by feeding into a roll mill. The free-standing films are then (or simultaneous with film formation) laminated to metal foil current collectors, perhaps following additional passes through the roll mill to attain the desired film thickness and porosity. The free-standing film may be formed by calendering the fibrillized material at a roll temperature and roll speed under a hydraulic pressure. The roll temperature may be from about room temperature (20 degrees Celsius) to about 180 degrees Celsius. A higher roll temperature may result in a thinner free-standing film on the first pass compared to a lower temperature. Additionally, the roll speed may be set from about 0.1 meters per minute to 25 meters per minute or higher, optionally 0.17 meters per minute to about 1.3 meters per minute. A slower roll speed may result in a thinner film on the first pass compared to a faster roll speed. A hydraulic pressure of about 1,000 psi to about 7,000 psi may be used. A higher pressure may result in a thinner film on the first pass compared to a lower pressure. The pressure can be tuned through adjusting of the roller gap that ranging from 0-1.2 mm with a gap tolerance as low as 10 μm. Additional passes through the roll mill may continue to reduce the film thickness until desired thickness, porosity, and loading are obtained. The step of compressing is optionally in the presence of liquid at less than or equal to 10 weight percent. In some aspects, the step of compressing is at less than or equal to 1 weight percent. Optionally the step of compressing is in the presence of liquid (optionally liquid processing aid) of less than or equal to a weight percent of 10, 9, 8, 7, 6, 5, 4, 3, 2, 1, 0.5 or 0.1.

While the inclusion of a liquid is not required, in some aspects an amount of a liquid processing aid may be used as a lubricant and/or to form a free standing film following extrusion from the screw fibrillator. Optionally, processing into a film includes contacting the fibrillized materials with a liquid processing aid substantially as described in WO/2019/200374. Briefly, a fibrillized material may be passed through a roll mill to form an initial free-standing film. A liquid processing aid is optionally contacted with the initial free-standing film in sufficient amount and for a sufficient time to form a wetted, well wetted or substantially saturated standing film. The liquid processing aid is optionally sprayed onto the surface of the initial free-standing film, layered onto the initial free standing film, expelled from one or more components of a roll mill, or the initial free-standing film is immersed in or layered on top of a liquid processing aid until a wetted free-standing film is formed. In other aspects, or in addition, a liquid processing aid may be added to the screw fibrillator at one or more stages of the process.

Illustrative examples of a liquid processing aid include an alcohol, a carbonate, a ketone, an acetate, or other suitable processing aid. Specific non-limiting examples of a liquid processing aid include acetone, dimethyl carbonate (DMC), ethyl acetate, anisole, ethanol, and isopropyl alcohol. If the temperature of the system is raised during rolling, the surface tension of a processing aid may also change so as to be within the range of 30 dynes/cm or less. An illustrative example of such a liquid processing aid is N-methyl-2-pyrilidone, which was found to be functional at a rolling temperature of about 100° C. or greater. Water is optionally excluded as a liquid processing aid.

In some aspects of the disclosure, an example, without limitation, a film thickness may be about 10 μm to about 150 μm, optionally about 20 μm to about 50 μm, optionally about 50 μm to about 100 μm, optionally about 100 μm to about 150 μm, optionally about 10 μm, optionally about 15 μm, optionally about 20 μm, about 25 μm, about 30 μm, about 35 μm, about 40 μm, about 45 μm, about 50 μm, about 55 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, or about 150 μm. A film thickness may be from about 40 μm to about 1.2 mm, optionally about 50 μm to about 100 μm, optionally about 100 μm or less, optionally about 50 μm or less.

If desired, a free-standing film can be passed through a horizontal mill set at 25 ° C.-100° C. until a desired thickness and loading are obtained. If desired, a metal or carbon current collector can be placed between two free-standing films and passed through a horizontal mill heated to about 100° C. to produce a laminated electrode.

Following formation of the initial free-standing film, optional contacting with the liquid processing aid, and formation of the film, in some aspects, the film is then laminated to a conductive substrate to optionally serve as a current collector, optionally a current collector including a conductive metal. The current collector may be an aluminum foil or mesh, a copper foil or mesh or optionally another conductive metal foil or mesh. Lamination may occur by rolling the film together with the metal foil current collector at a roll temperature and roll speed under a hydraulic pressure. The roll temperature is optionally about 100 degrees Celsius, about optionally 80 degrees Celsius, optionally about 90 degrees Celsius, optionally 80 degrees Celsius to 100 degrees Celsius. It is appreciated that the higher the roll temperature the greater the likelihood of blistering and poor adhesion. Similarly, the lower the roll temperature the worse the adhesion. Additionally, the roll speed may be from about 0.17 meters per minute to about 1.3 meters per minute, optionally about 0.5 meters per minute. Finally, the hydraulic pressure may be set from about 500 psi to about 2,000 psi. The pressure is set to promote adhesion to the substrate but not such that the chemical properties, for example loading and porosity, are altered. When the pressure is set too high the chemical properties are affected, but when the pressure is set too low adhesion may not occur.

The current collector may be an aluminum foil or mesh, a copper foil or mesh or optionally another conductive metal foil or mesh, or conductive primer-coated metal foil or mesh. The electrode precursor material is appreciated to be a free-flowing powder. The improved processibility of the materials formed using the methods as described herein may be further enhanced by the dry aspects of the materials that enable lower cost electrode manufacturing and higher performance batteries.

Also provided herein are electrochemical cells that include an anode, a cathode, an electrolyte, or any combination thereof where at least one of the anode, cathode, or electrolyte is produced at least in part using a process as provided herein. Optionally, an electrochemical cell is a lithium ion battery meaning that lithium is used as the charge carrier between the anode and the cathode in the operation of the electrochemical cell. Optionally, an electrochemical cell is a solid state cell as understood in the art.

Electrochemical cells as provided herein include an electrolyte. An electrolyte is optionally a solid or fluid electrolyte. Illustratively, the electrolyte includes a lithium salt and a non-aqueous organic solvent. A lithium salt is optionally LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiCl, LiI, or LiB(C₂O₄)₂ (lithium bis(oxalato) borate; LiBOB), bis-(trifluoromethane)sulfonamide lithium (LiTFSI), LiNO₃. The lithium salt is optionally present in a concentration ranging from about 0.1 M to about 2.0 M. When the lithium salt is included at the above concentration range, an electrolyte may have excellent performance and lithium ion mobility due to optimal electrolyte conductivity and viscosity.

Electrochemical cells using an electrode with an active material made using the processes as provided herein demonstrate greatly improved cycle life relative to those without an electrode made by traditional processes. A cell with an electrode made using a screw fibrillator as provided herein optionally demonstrates a cycle life (measured at 80% capacity retention) of 100 cycles or greater. Cycle life is optionally measured against a lithium counter electrode. Cycle life of a cell as provided herein is optionally at or in excess of 125 cycles, optionally 150 cycles, optionally 175 cycles, optionally 200 cycles.

The electrochemical cells formed using one or more electrodes with electrochemically active materials produced as provided herein and/or an electrolyte produced as provided herein is optionally a solid state cell such as that understood to be used in a solid state battery. A solid state battery or cell optionally excludes a liquid electrolyte. As such, an electrolyte as produced in the processes as provided herein optionally includes less than or equal to 30 wt %, optionally at or less than 25 wt %, 20 wt %, 15 wt %, 10 wt %, 5 wt %, 4 wt %, 3 wt %, 2 wt % or 1 wt %, or less.

An electrochemical cell optionally includes a separator. The separator can be made from, for example, polymers such as polyvinylidene fluoride (PVDF), polyvinylidene fluoride-co-hexafluoropropylene (PVDF-HFP), polyethylene (PE), polypropylene (PP), glass fiber, or similar polymers and inorganic additives such as clays or organically modified clays (e.g., clays including cationically or anionically or chemically modified surface functional group(s)). Other separator materials may also be used.

Batteries as provided herein optionally include one or more electrochemical cells with at least one component produced as provided herein. A battery optionally includes 1, 2, 3, 4, or more electrochemical cells.

The processes and electrode/electrolyte films produced by the processes as provided herein achieve a dry manufacture method that creates excellent electrochemical properties to resulting electrodes suitable for use in lithium ion or other cells.

Various aspects of the present disclosure are illustrated by the following non-limiting examples. The examples are for illustrative purposes and are not a limitation on any practice of the present disclosure. It will be understood that variations and modifications can be made without departing from the spirit and scope of the disclosure. Reagents and materials illustrated herein are obtained from commercial sources unless otherwise indicated.

### EXPERIMENTAL

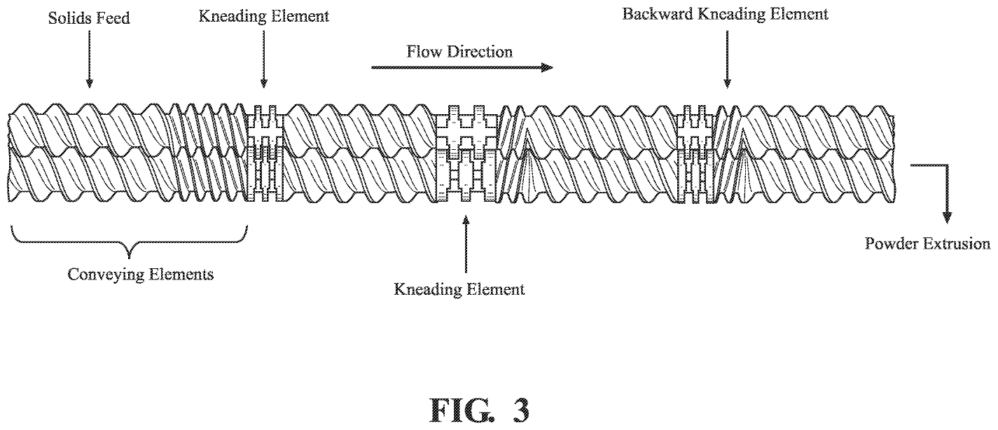

Anode electrode films were produced by combining 95% Graphite, 2.5% activated carbon and 2.5% PTFE composition by weight. The combination was mixed at low shear using a Resodyn Acoustic mixer LabRAM II to prevent pre-mature fibrillization until a substantially homogenous mix was obtained. The resulting mixture was then added to main port of a TSE (for example as available from THERMOFISHER SCIENTIFIC) at a rate of 1.6 kg/hr. The TSE had a 20 mm barrel diameter and a die plate with 15 mm nozzle attached at the end. Screw speed was 300 revolutions per minute (RPM), 8% torque and an outlet pressure of 4.9 bar. The extruder was comprised of varying screw designs capable of kneading, fibrillating and pushing the mixture through the chamber as illustrated in FIG. 3.

The TSE chamber was kept at 40° C. A processing aid, such as IPA or DMC, may optionally be added to a second port of the TSE to produce a mixture with 60-90% solid content. The material was extruded through a die plate with a 15 millimeter (mm) nozzle at a pressure of 9.6 bar and produced a continuous rod shape. The rod of test electrode material was chopped into a fine powder and passed through a 355 micron mesh.

A comparator electrode film was made using the identical composition, but the material formed using a jet mill at ˜90 psi pressure, 41 standard cubic feet per minute (SCFM) of house compressed air. The resulting electrode material was then passed through 355 micron sieve.

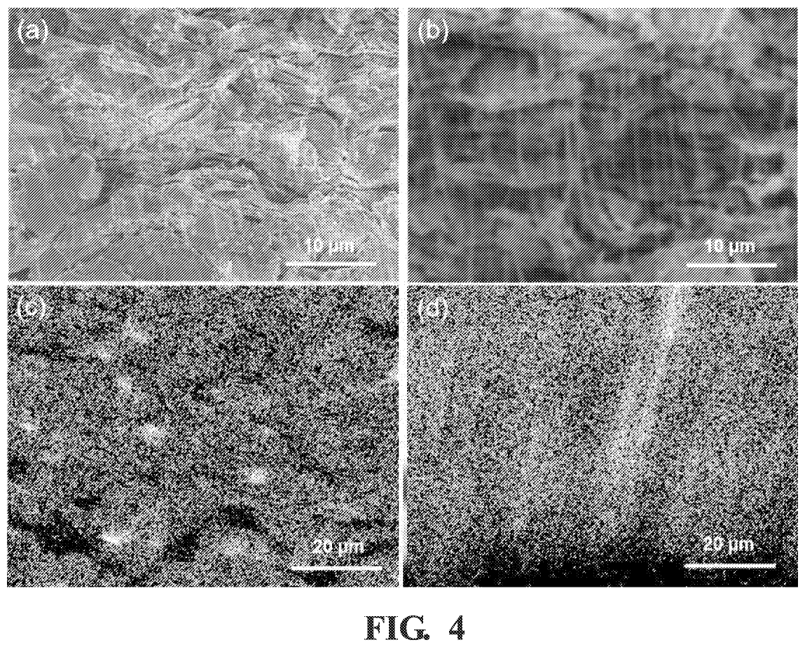

The test and comparator materials were analyzed by scanning electron microscopy and energy dispersive X-ray spectroscopy (EDS) with results illustrated in FIG. 4. Cross-section SEM images (a and b) and EDS mapping of fluorine (c and d) of the dry processed graphite anode films indicated a higher degree of PTFE binder fibrillization in the screw fibrillator dry process anode (b, d) than jet mill baseline dry process anode (a, c). Both films contain 95% graphite, 2.5% active carbon, 2.5% PTFE by weight.

The comparator material is illustrated in FIG. 4a demonstrates binder fibril formation and functional binding of the electrochemically active graphite. FIG. 4b illustrates the test material produced by processing in a TSE. The fibril formation of the test sample shows a significant increase in the presence of fibrils and a much more uniform binder distribution. The area in jet mill sample (FIG. 4a) that has high PTFE fiber density was <40%, while that in TSE sample (FIG. 4b) estimated to >80%, indicating about 2 times increase of binder fibrillization and/or distribution uniformity. In addition, there is large amount of non-fibrillized PTFE left in the jet mill film, indicated by the spherical spots in the fluorine-map of the cross-section of jet mill film (FIG. 4c), while the major morphology in the fluorine-map of the cross session of TSE film is linear shape (FIG. 4d), indicating most of PTFE has been effectively fibrillized.

Sieved powder of the test and comparator materials were passed through a vertical roll mill to obtain an initial free-standing film. This was then passed through a horizontal roll mill until a thickness of 65 μm and/or electrochemical loading of 3.5 mAh/cm² were obtained. The resulting films were subjected to physical testing for robustness by placing a 60 mm long sample with a width of 20 mm between two clamps. Using a 25 KgF load cell, the sample was stretched by moving the top clamp at a rate of 2.00 mm/min until the sample broke. The bottom clamp was held stationary. The results are illustrated in Table 1.

TABLE 1
Physical parameters of electrode films.

| | | Young's | Tensile |
|---|---|---|---|
| | Force @ | Modulus | Strength |
| Samples | Peak (N) | (N/mm²) | (N/mm²) |
| Jet Mill Film | 0.63 | 118.6 | 0.47 |
| Screw Fibrillator Film | 0.89 | 185.3 | 0.73 |

These results show that the test film produced using material made by the screw fibrillator process can withstand over twice the force of the film produced using the comparator material. This is also shown in the significant increases in both Young's modulus and tensile strength of the test material.

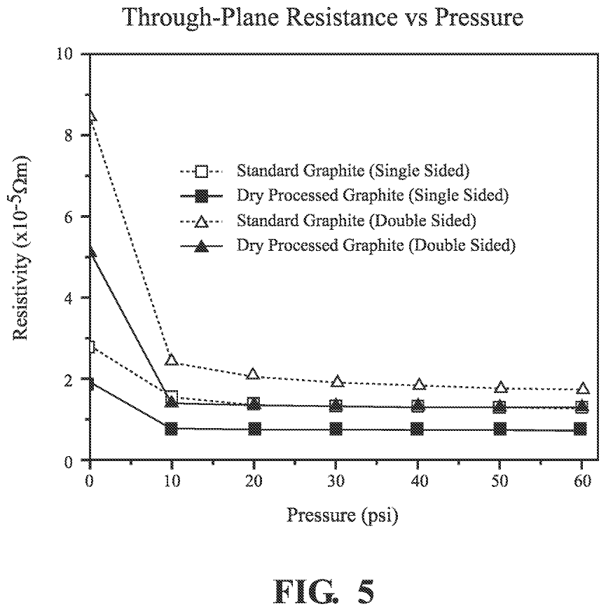

The TSE material was also subjected to testing by through-plane resistance v. pressure substantially as described by Cooper, K., Journal of The Electrochemical Society, 157(11), pgs. B1731-B1739 (2010), with a traditional slurry cast graphite anode film as a standard for comparison. The results depicted in FIG. 5 were produced comparing a twin screw fibrillator produced graphite anode as produced by the above processes on Cu foil relative to a standard (slurry cast) graphite anode. Both anodes were fabricated to 4.5 mAh/cm² and 25% porosity. The results demonstrate improved electrode uniformity and superior electrochemical performance relative to the identical materials produced using traditional methods.

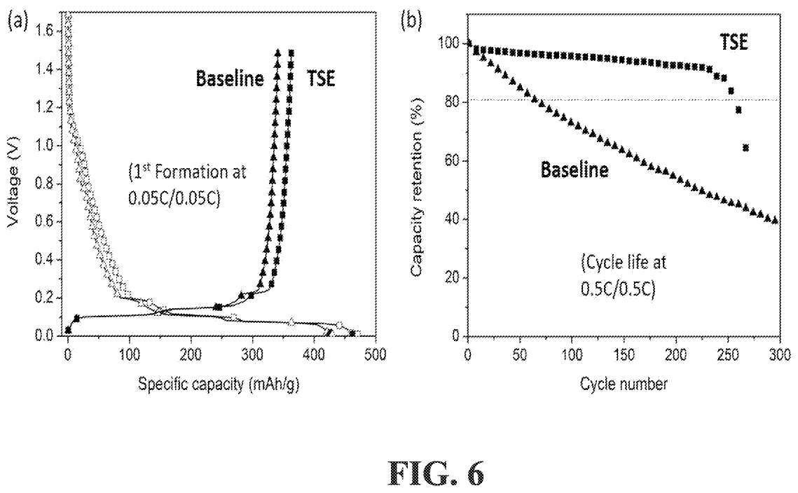

FIG. 6a illustrates the voltage profiles in the first formation cycle of coin cells made with an anode including a graphite anode electrochemically active film produced in a screw fibrillator as above (square) and baseline graphite anode produced by knife blender (triangle) each paired with a lithium cathode and carbonate electrolyte. Both films contain 95% graphite, 2.5% active carbon, 2.5% PTFE by weight with reversible loading around 3.0 mAh/cm². The cells were cycled at 0.05 C charge, 0.05 C discharge between 0.01-1.5V. FIG. 6b illustrates the capacity retention of above coin cells at 0.5 C charge, 0.5C discharge between 0.01-1.2V, in which the cell with a baseline graphite film produced by knife blender (triangles) showed a rapid capacity fade with cycle life of 68 cycles (80% capacity retention) and only 54% capacity retention at the 200^{th} cycle. In contrast, the cell made with an anode formed using a screw fibrillator produced (squares) exhibited much slower capacity fading with 94% capacity retention at the 200^{th} cycle, and cycle life of 258 cycles (80% capacity retention), which was 3.8 times as that of traditionally formed cells.

Overall, these results demonstrate that identical electrode materials formed by fibrillating binder using a dry process in a screw fibrillator produces greatly improved fibrillation and resulting improvements in film physical properties as well as electrochemical performance.

The forgoing description of particular aspect(s) is merely exemplary in nature and is in no way intended to limit the scope of the disclosure, its application, or uses, which may, of course, vary. The materials and processes are described with relation to the non-limiting definitions and terminology included herein. These definitions and terminology are not designed to function as a limitation on the scope or practice of the disclosure, but are presented for illustrative and descriptive purposes only. While the processes or compositions are described as an order of individual steps or using specific materials, it is appreciated that steps or materials may be interchangeable such that the description of the disclosure may include multiple parts or steps arranged in many ways as is readily appreciated by one of skill in the art.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first ‘element’”, “component,” “region,” “layer,” or “section” discussed below could be termed a second (or other) element, component, region, layer, or section without departing from the teachings herein.

The terminology used herein is for the purpose of describing particular aspects of the disclosure only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular aspects of the disclosure, but is not meant to be a limitation upon the practice thereof.

1. A process for forming a fibrillized material suitable for use in an electrochemical cell comprising:
combining an electrochemically active material or a solid-state electrolyte material with a fibrillizable binder to form a precursor material; and
intermixing said precursor material in a screw fibrillator to form a fibrillized material.

2. The process of claim 1, wherein the precursor material includes 30 wt % or less of a liquid.

3. The process of claim 1 wherein the precursor material includes 1 wt % or less of a liquid.

4. The process of claim 1, wherein said fibrillizable binder is present at less than 5 weight percent.

5. The process of claim 1 further comprising combining a fibrillization promoter with said precursor material.

6. The process of claim 5, wherein said fibrillization promoter comprises activated carbon, a silica-templated high-porosity particle, a graphitized particle, a pyrolized material, or combinations thereof.

7. (canceled)

8. The process of claim 1, wherein the step of intermixing is at a temperature in excess of 25° C.

9. The process of claim 1, wherein said step of combining is in a mixer under low shear.

10. The process of claim 1, wherein said fibrillizable binder comprises polytetrafluoroethylene, PVDF, or combinations thereof.

11-12. (canceled)

13. The process of claim 1, further comprising compressing said fibrillized material into a film.

14. The process of claim 13, further comprising laminating said film to a conductive substrate to form an electrode.

15. The process of claim 13, further comprising contacting said film with a liquid processing aid.

16. The process of claim 13, wherein said film comprises a thickness from 20 to 200 micrometers.

17-18. (canceled)

19. The process of claim 1, wherein said active electrode material comprises Lithium Nickel Manganese Cobalt Oxide (NMC), Lithium Nickel Cobalt Aluminum Oxide (NCA), Lithium Cobalt Oxide (LCO), graphite, silicon, composite material suitable for use in an anode of a lithium ion cell, or combinations thereof.

20. (canceled)

21. The process of claim 1, wherein said precursor material comprises a solid-state electrolyte material selected from the group consisting of poly(ethylene oxide), polycarbonate, polysiloxane, succinonitrile, and organic-inorganic hybrid composites.

22. A film suitable for use as an electrode active material or an electrolyte in a lithium ion cell, the film having a Young's modulus of greater than 100 N/mm² or the film having a tensile strength of greater than 0.6 N/mm².

23. (canceled)

24. The film of claim 22, the film comprising poly(ethylene oxide), polycarbonate, polysiloxane, succinonitrile, and organic-inorganic hybrid composites; and
fibrillizable binder, said fibrillizable binder present at less than 5 weight percent.

25. The film of claim 24 comprising lithium sulfide and phosphorous pentasulfide.

26. The film of claim 25, wherein the lithium sulfide is present at 50 mol. % to 90 mol. %, or any value or range therebetween.

27. An electrochemical cell comprising an electrode comprising the film of claim 22.

28-30. (canceled)
